(19) United States
(12) Patent Application Publication
(10) Pub. No.: US 2005/0128873 A1
(43) Pub. Date: Jun. 16, 2005

(54) Acoustic device and method for determining interface integrity

(76) Inventor: Kenneth J. LaBry, Lafayette, LA (US)

Correspondence Address: DOMINGUE & WADDELL, PLC, P.O. Box 3405, LAFAYETTE, LA, 70502, US

(21) Appl. No.: 10/737,201

(22) Filed: Dec. 16, 2003

(51) Int. Cl. G01V 1/40

(52) U.S. Cl. 367/35

(57) ABSTRACT

A method and system for acoustically logging a tubular for an interface with a material. The method includes having a tubular disposed within a bore hole with the material being disposed within the annulus. The method comprises producing a first acoustic ping from an acoustic sensor located in the tubular, and recording a plurality of sample readings. The method then includes establishing a first time gate defining a sample window that is inclusive of samples representing compressional wave reflections from the perpendicular incidence of the acoustic ping and first contact with the inner tubular wall, and recording the sample set defined by the first time gate. Next, the acoustic sensor is rotated and a second acoustic ping is produced. The method further comprises establishing a second time gate defining a sample window that is inclusive of samples representing compressional wave reflections from the perpendicular incidence of the acoustic ping and first contact with the inner tubular wall and recording the sample set defined by the second time gate.

### BACKGROUND OF THE INVENTION

This invention relates to a method and system for determining the environmental interface integrity of a fluid filled tubular. More particularly, but not by way of limitation, this invention relates to the use of sonar sensor technology to determine the interface integrity of a tubular having cement material disposed about the tubular's outer diameter portion.

In the drilling of oil and gas wells, operators find it necessary to place a tubular string within a second tubular string, or within a bore hole. In order to hold the tubular string in place, a material such as cement is placed within the annulus. The cement bonds to the outer diameter portion of the tubular so that the tubular is held in place.

As understood by those of ordinary skill in the art, the bonded cement produces several beneficial effects. For instance, the tubular is held in place. Also, communication from one subterranean zone to another zone is prevented. Additionally, the cement precludes migration of subterranean pressure to the surface.

Unfortunately, many times voids, cracks and fissures exist within the annulus area containing the cement. The voids, cracks and fissures can countermine the whole purpose of the cement. In fact, in some cases the voids, cracks and fissures can become a safety hazard for rig and crew. Therefore, when these voids, cracks and/or fissures are discovered, remedial efforts can be undertaken to cure the problem. For example, a cement squeeze operation can be performed. It should be noted that the invention is also applicable to evaluating all types of material interface that includes but not limited to cement, soil, etc.

In an effort to determine interface integrity, including cement-bonding integrity, numerous devices have been developed. Some of these devices include an acoustic transmitter lowered into a tubular and wherein an acoustic signal is generated and reflections are recorded. The reflections contain information useful for determining the presence of voids, cracks and fissures. However, the prior art devices suffer from many problems. For instance, prior art devices attempt to calculate the relative thickness of the tubular, the fill material, etc. Also, the prior art devices use complicated methodologies for calculating thickness that require centralization of the tool that are in some cases unreliable and undependable.

Therefore, there is a need for a method and system that will analyze the tubular interface environment. There is also a need for a method and system that will accurately and correctly identify interfaces voids. These and many other needs will be met by the invention herein described, which will be apparent from a reading of the following.

### SUMMARY OF THE INVENTION

A method for acoustically logging a tubular, of uniform construction, for an interface with a material is disclosed. The tubular is disposed within a bore-hole so that an annulus is formed between the tubular and the borehole and the material is disposed within the annulus. The method comprises producing a first acoustic fan beam ping from an acoustic sensor located in the tubular, and recording a plurality of sample readings. The method then includes establishing a first time gate that defines a sample window corresponding to a desired set of acoustic amplitude samples from the compressional acoustic wave reflection from the tubular and subsequently recording the corresponding amplitude values and associated positional information. Next, the acoustic sensor is rotated and a second acoustic fan beam ping from the acoustic sensor is produced and the process is reiterated.

The method further comprises establishing a second time gate that defines a sample window corresponding to a desired set of acoustic amplitude samples from the compressional acoustic wave reflection from the tubular and recording the corresponding amplitude values and associated positional information.

The method further comprises positioning the acoustic sensor at a second depth, establishing a third time gate corresponding to a desired set of acoustic samples and recording the corresponding amplitude values and associated positional information.

In one of the preferred embodiments, the step of establishing the time gates comprises: obtaining a first plurality of sample readings corresponding to before pipe wall interaction; obtaining a second plurality of sample readings corresponding to a sample window defined by a time interval that includes the compressional wave reflections that are produced from a perpendicular angle of incidence with the tubular inner wall and correspond in time to the first instance of that reflected compressional wave; and, obtaining a third plurality of sample readings that correspond to noise reflections.

Additionally, in one of the preferred embodiments, the step of obtaining the samples (readings) includes recording the samples in a recording means operatively associated with the acoustic sensor located within the tubular and directing the recorded samples to a surface processor, and the method further comprises processing the samples at the surface for interface integrity between the tubular and its surrounding material.

The method further comprises measuring amplitude and positional values of the samples within the first, second, third and successive sample windows defined by the time gates, as the acoustic signal describes a spiral arc along the length of the tubular. Next, a pattern of baseline amplitude values is mapped and sustained differences of significantly larger amplitude values of approximately two times the baseline amplitude values or greater represent an area void of secondary material support.

In one preferred embodiment, the samples are obtained at a rate of approximately 35 KHz and wherein a plurality of readings comprising 48 samples is segmented by time gate definition of a 24 sample window and said window is applicable to each scan step corresponding to each individual ping of the sonar transducer. In one of the preferred embodiments, the step of rotating the sonar includes rotating the sonar in scan increments of 0.225 degrees.

A system for determining the integrity of an interface to a tubular is also disclosed. The system comprises an acoustic fan beam generator for generating an acoustic beam, with the beam generator located on a tool within the tubular, and wherein the beam generator generates a sonar data set and the beam generator records the sonar data set. The system includes a surface processor receiving the sonar data set via a telemetry means for transmitting the sonar data set from within the tubular to the surface processor.

The system further includes a time gate means, operatively associated with the surface processor, for establishing a time gate that defines a sample window that encompasses a time frame which is inclusive of compressional wave reflections that are produced from a perpendicular angle of incidence with the tubular inner wall and correspond in time to the first instance of that reflected compressional wave.

In the most preferred embodiment, the beam generator comprises a rotating generator for rotating in a 360-degree phase within the tubular.

The system may also include means, operatively associated with the beam generator, for recording the sonar data set.

In the most preferred embodiment, the telemetry means is an electric line connected at a first end to the acoustic fan beam generator and at a second end to the surface processor and wherein the surface processor contains means for converting the sonar data set to an amplitude file.

Additionally, the surface processor may include an amplitude comparing means for comparing the amplitude file of the sonar data set.

In one preferred embodiment, the beam generator time tags the data set and the surface processor synchronizes the time tagged data set with the amplitude file.

In the most preferred embodiment of this invention, the rotating sensor obtains samples at a rate of approximately 35 KHz.

An advantage is that the present invention can be used to detect void areas or areas lacking support from a material, and wherein the material may be cement, soil, and other filler materials. Another advantage is that the invention may be used in traditional well bores found in the oil and gas industry. Yet another advantage is the invention may also be used in other environments wherein a first tubular is disposed within a second concentric tubular and wherein the annulus contains a support fill material.

Another advantage of the present invention is that it is possible to generate historical baselines that provide analytical guidelines by mapping different case scenarios in a controlled situation, where the acoustic characteristics of areas of pipe that are void of backing, support, or frictional interface beyond the outside surface of the pipe wall would be mapped and used for analytical reference and comparative analysis.

Another advantage of the present invention includes that a strip-chart graph can be plotted from the processed data by depth or distance from launch point and correlated acoustic amplitudes and a visual color encoded image representing cross-sections of the cylinder and again reference by depth or distance from launch point. Areas indicating acoustic anomalies would be represented by depth or distance from launch point and the length and circumferential area of the anomaly. This would provide an indication of areas that lack pipe support and have compromised pipe wall integrity.

### BRIEF DESCRIPTION OF THE DRAWINGS

FIG. 1 is schematic view of the preferred embodiment of the tool of the present invention.

FIG. 2 is a schematic view of the tool of FIG. 1 in a well bore depicting the acoustic beam pattern.

FIG. 3A is a plan view of the acoustic pulse in a well bore.

FIG. 3B is a plan view of the reflection pattern from the acoustic pulse of FIG. 3A.

FIG. 4 is a plan view of the acoustic pulse and reflection pattern in a well bore that depicts the beyond tubular wall area of interest.

FIG. 5 is a systems diagram of the present invention.

FIG. 6A is a plan view of the transducer initialing an acoustic pulse in a tubular.

FIG. 6B is a plan view of the transducer in a sequential stationary mode receiving acoustic reflections.

FIG. 6C is a plan view of the transducer having been rotated.

FIG. 6D is a plan view of the transducer in a sequential stationary mode receiving acoustic reflections.

FIG. 7 is a data flow diagram of the present invention.

FIG. 8 is a time alignment diagram of the inner tubular wall position within the recorded samples at each ping/step of the transducer, where time is represented in sample numbers.

FIG. 9 is a representative log plot depicting a void surrounding the tubular. FIG. 10 is a plan view of reflected acoustic compressional waves in a well bore.

### DETAILED DESCRIPTION OF THE PREFERRED EMBODIMENTS

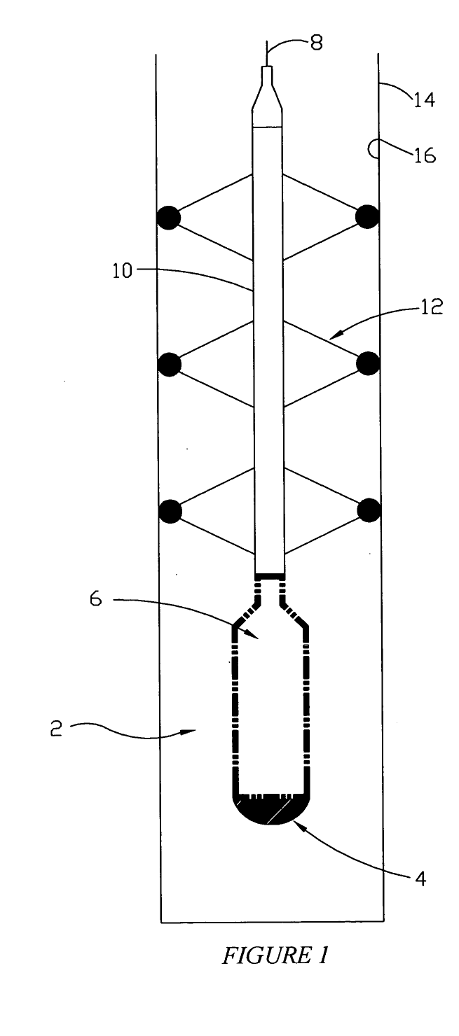

Referring to FIG. 1, a schematic view of the preferred embodiment of the tool of the present invention will now be described. The invention herein described utilizes a scanning sonar sensor and imaging device 2 for use in large diameter tubular inspection and tubular support analysis in earth penetration and uniform contact support situation.

In the preferred embodiment, the imaging device 2 consist of a scanning sonar transducer 4 that is a 360 degree sector scanning acoustic imaging tool. The sensor device 2 further comprises a sensor and acoustic signal processor 6 that is operatively attached to the scanning sonar transducer 4. The sonar sensor and imaging device 2 is commercially available from Simrad Inc. under the name Digital Mechanically scanned sonar Model # 974-2104. The device 2 further includes a data uplink means 8 for telemetering the collected data to the surface, which in the preferred embodiment is an electric wireline 8. The device 2 is interfaced to an electric wireline unit to provide power, control, data transfer, and down hole deployment, as will be understood by those of ordinary skill in the art. The wireline unit is operatively connected to a surface processor for data processing and recording as will be described in greater detail later in the application.

A series of multi-conductor sinker bars 10 is also included. The sinker bars 10 are used to add weight to the imaging device 2 and to provide an attachment platform for the centralizing stabilizers 12. The centralizing stabilizers 12 used are conventional centralizers as used in borehole gyroscopic surveys and commercially available from Applied Electronic Systems under the name Centralizer. The stabilizers 12 will abut the inner diameter portion of the tubular 14 (sometimes referred to as pipe 14).

In operation, the device 2 is deployed to the bottom or far end of the section of pipe 14 to be inspected and then pulled up or through the section at a constant rate of travel by the electric wireline 8 while scanning the inner pipe wall (denoted by numeral 16). This generates a data set that traces a spiral arc of compressional wave reflections, which are a result of a perpendicular angle of incidence interaction between the pipe wall and the generated pulse transmission, along the length of the tubular being surveyed. Generally, the method includes measuring the amplitude of the first acoustic reflection of a perpendicular incident compressional wave, from the inner pipe wall 16 and using these measurements to create a log and visual map. Translating the amplitude values to color and brightness values for a visual representation, which would produce the visual map, is also provided. This is then plotted against distance down the pipe 14 from the point of insertion of the imaging device 2 so that relative positions of anomalous indications could be represented. The amplitude of the reflected acoustic pulse is directly related to the integrity of the pipe 14 and the support of the pipe 14 by any material in contact with the outside wall of the pipe 14. The amplitude differences in regions of suspended or free pipe have been shown to vary significantly from those where the pipe is supported. As herein disclosed, a comparative analysis of the amplitude values gives a representation of where pipe 14 is supported and where support is lacking and also provides an approximation of the extent of the area lacking support. The specific method of collecting and processing the acoustic data will be explained in greater detail later in the application.

The scan rate can be adjusted to allow for overlap of the acoustic fan beam thus ensuring full coverage across the pipe circumference. The scanning sonar transducer 4 is performing 360-degree scans around the inner circumference of the pipe wall as it moves laterally along the pipe.

During the tool run and data acquisition, the data collected via the down hole processor 6 is telemetered through the electric wireline 8 to a computer that translates the acoustic responses onto a strip-chart or log and a cross-sectional visual map of the pipe cylinder, as well as recording the acoustic data digitally. As will be more fully explained later in the application, a calibrated acoustic sensor is utilized for this purpose operating at a frequency of 330 KHz. The depth of the transducer 4 is recorded using the cable counter of the surface wireline unit with logging software that includes time tagging means for correlating the depth counter of the wireline 8 with the telemetered acoustic data, which in turn provides time tagging synchronicity with sonar data.

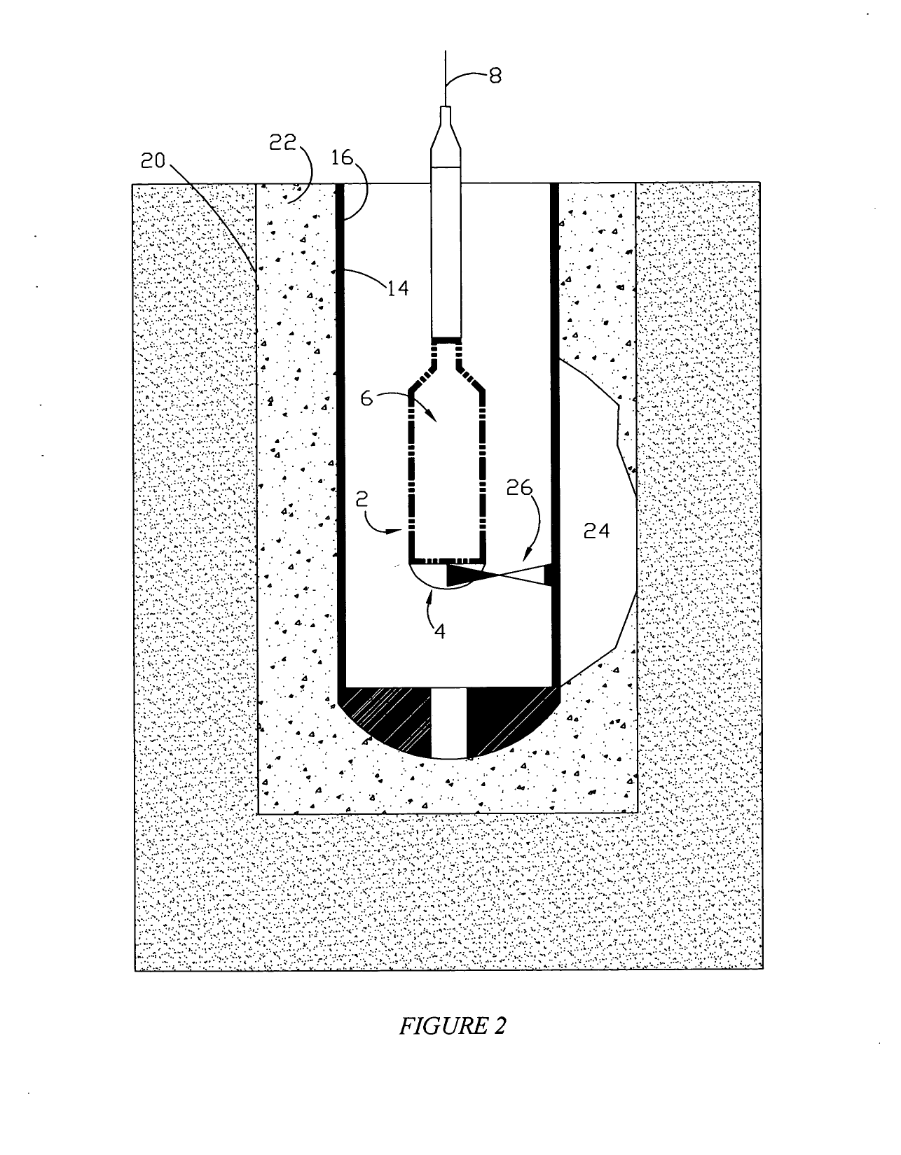

Referring now to FIG. 2, a schematic view of the tool of FIG. 1 in a tubular 14 depicting the acoustic beam pattern will now be described. More specifically, the schematic depicts the device 2 being suspended from wireline 8. The tubular 16 is disposed within a bore hole 20 and wherein the bore hole 20 and tubular 14 form an annular area 22 and wherein the annular area is filled with a fill material that may be cement in one preferred embodiment. FIG. 2 also depicts a void 24 which, as is readily understood by those of ordinary skill in the art, is an undesirable feature. FIG. 2 also depicts the acoustic fan beam 26 which is produced by the transducer 4. The acoustic fan beam 26 has a 2.7 degree horizontal resolution and 40 degree vertical resolution.

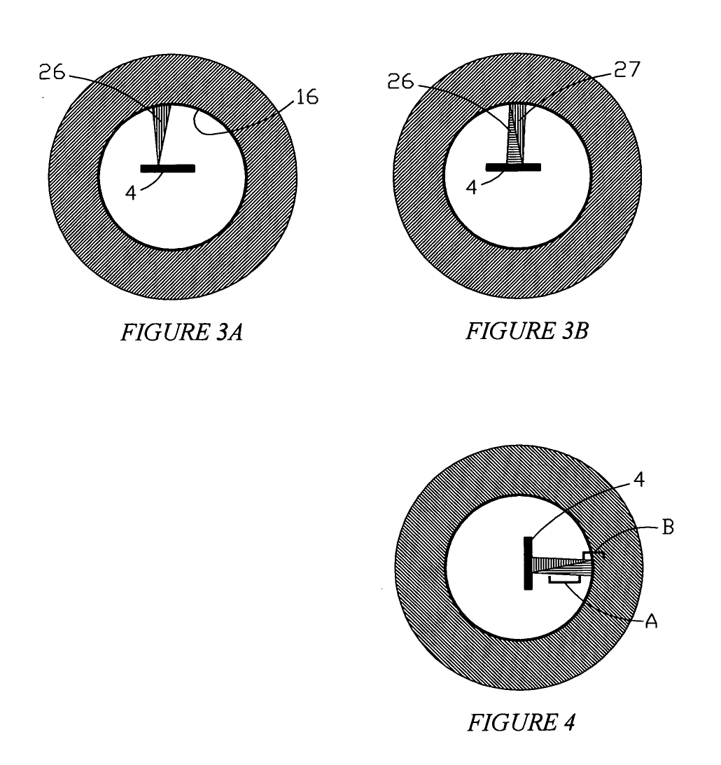

FIG. 3A depicts a plan view of the acoustic pulse in a bore hole. The acoustic ping 26 from the transducer 4 intersects the pipe wall 16 at a perpendicular angle of incidence producing a reflected compressional acoustic wave the intensity of which is directly correlatable to the integrity of the support beyond the pipe wall 16. The density and rigidity of the backing support is directly related to the amplitude attenuation of the reflected acoustic wave. FIG. 3B is a plan view of the reflection pattern 27 from the acoustic pulse of FIG. 3A. The transducer 4 measures the amplitude of the acoustic reflection.

Prior art devices have problems in qualifying void areas of structural significance 24 because of signatures introduced by micro annulus or small fissures. These problems are resolved by the present invention by analyzing and comparing sustained amplitude patterns and discarding or ignoring sporadic amplitude anomalies.

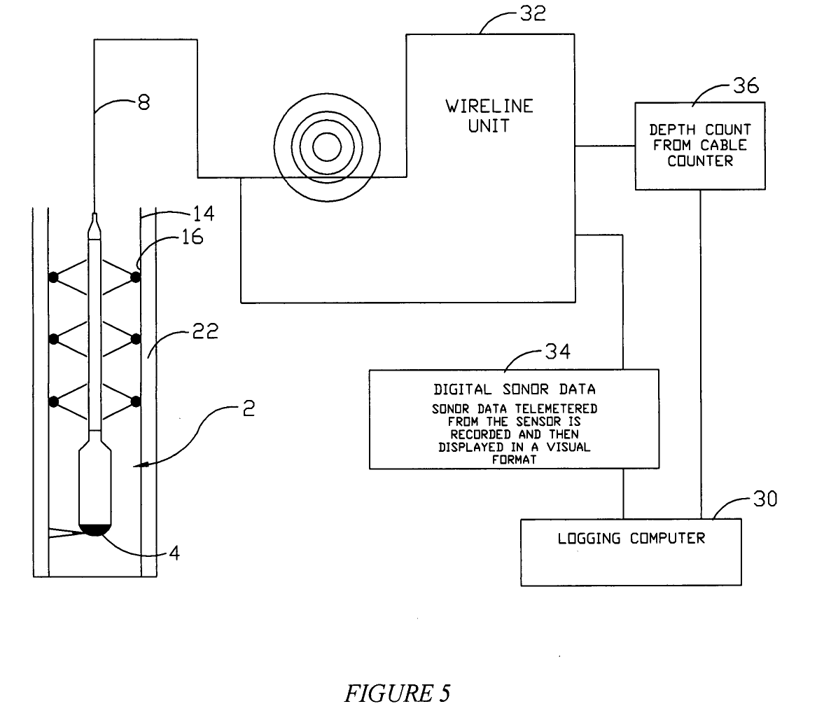

FIG. 4 is a plan view of the acoustic pulse and reflection pattern in a bore hole that depicts the beyond tubular wall area of interest. The acoustic returns over a gated time interval corresponding to prior to pipe wall interaction correspond to “A” in FIG. 4. The acoustic returns corresponding to beyond pipe wall interaction (and which are of specific interest for determining whether a void exist) are depicted by “B” in FIG. 4.

In one preferred embodiment, the transducer 4 scans in step increments of 0.225 degrees. At a sample rate of approximately 35 KHz, 48 samples or readings are taken at each scan step. Thus, the transducer is performing over 700 steps per second. The samples are qualified by establishing a time gate, to define a subset sample window, where irrespective of centralization, the evaluated samples will encompass the reflected pulses from the pipe wall. Hence, the gate created will be 24 samples wide, with the inner pipe wall 25% from the leading edge of the sample gate. The leading edge of the sample time gate position is determined by the following:
S_{cd}=(d/s)0.0000285−6; wherein,
S_{cd} is the sample count depth of the first ping reflection arrival, of the leading edge of the time gate,
d is two times the distance from the transducer to the pipe wall, which is nominally the diameter of the pipe,
s is speed of sound or propagation velocity,
0.0000285 is the sample frequency in seconds, and
minus six (−6) is the offset value and sets the leading edge of the gate to six (6) samples before the inner pipe wall.

Hence, a sample window comprised of acoustic returns over a gated time interval corresponding to 6 samples/readings prior to pipe wall interaction and 18 samples beyond pipe wall interaction, and wherein the 24 samples of each respective sample window, are used for analysis as taught herein.

The reflection of interest is the compressional acoustic reflection of the perpendicular incidence of the acoustic pulse and the pipe wall, that occurs at T₀=2(r/s), wherein:
T₀ is the time in milliseconds from the initiated pulse generation from the transducer, to the incidence of the reflected acoustic compressional wave at the transducer,
r is the radius of the pipe or well casing, and
s is the speed of sound in the fluid medium that is filling the pipe or well casing.

The time T₀ is the time of applicability associated with the position of the acoustic information relative to the initiation of the ping that is of interest. Assuming that the sound velocity in the fluid medium is not precisely known, the process includes clipping the data around a gate which allows for a buffer defining a sample window that encapsulates the data of interest.

Empirical data has shown that the reflected amplitude from free pipe is at least twice that of bonded or supported pipe. By looking for sustained significant amplitude increases of at least twice the average amplitude of bonded pipe segments, it is possible to identify bond voids that are of concern to structural integrity. Practical experience has shown that a large percentage of an extensive pipe span of several hundred feet or more, as is the case in the surface pipe well casing interval, in oil and gas wells, will be adequately bonded. Therefore, on a case by case basis, a comparative data set can be derived and significant bond voids identified. This would be supported by the overall pattern of the total data set wherein a baseline amplitude value range is observed over the majority of the data and significant sustained increases in amplitude define areas of concern indicating a lack of tubular backing material support.

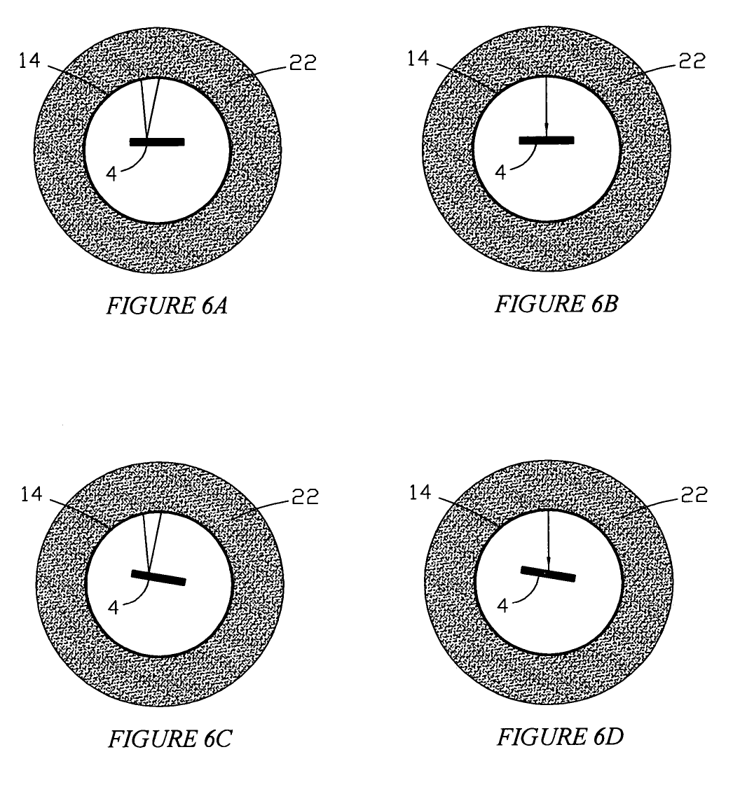

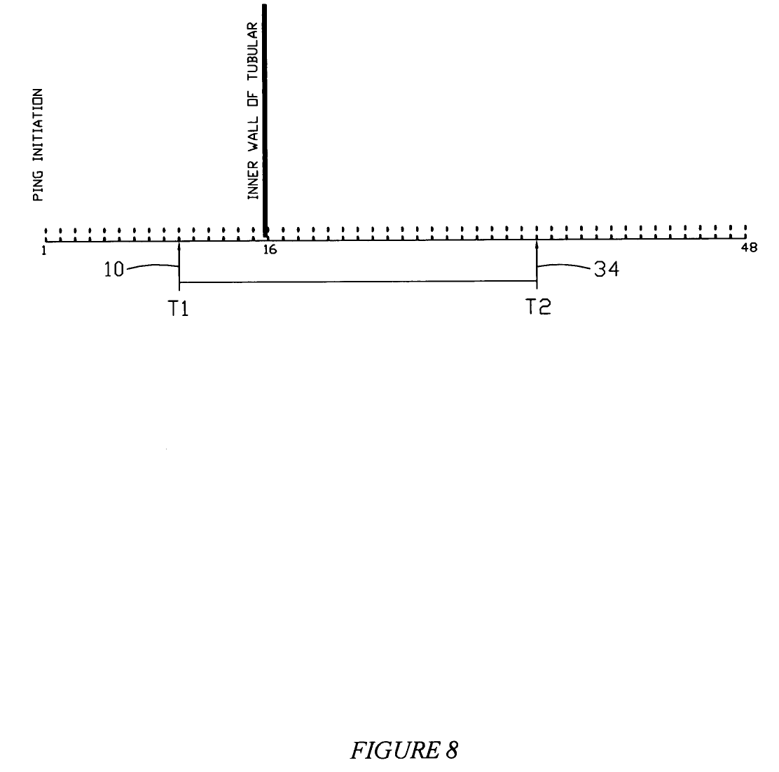

Referring to FIG. 5, a systems diagram of the present invention will now be described. The acoustic amplitude data is digitally recorded in the sonar sensor processor 6 and the data transmitted via the wireline 8 to the surface logging computer 30 for processing as will be more fully explained with reference to FIG. 7.

Returning to FIG. 5, the sonar data being collected is transmitted via the wireline 8, then through the wireline unit 32, and to the logging computer 30. In one of the preferred embodiments, the data transmitted consists of the following fields:
sensor identification number;
time (milliseconds);
range (centimeters);
gain;
pulse length (usec);
scan angle (0.225 degree increments);
sample rate (Hz);
sample count;
sonar data (acoustic reflection amplitudes).

Simultaneously therewith, the depth count from the cable counter located on the wireline unit 32 is also generated. Hence, the digital sonar data 34 is transmitted to the logging computer 30, and the depth count from the cable counter 36 is also transmitted to the logging computer 30.

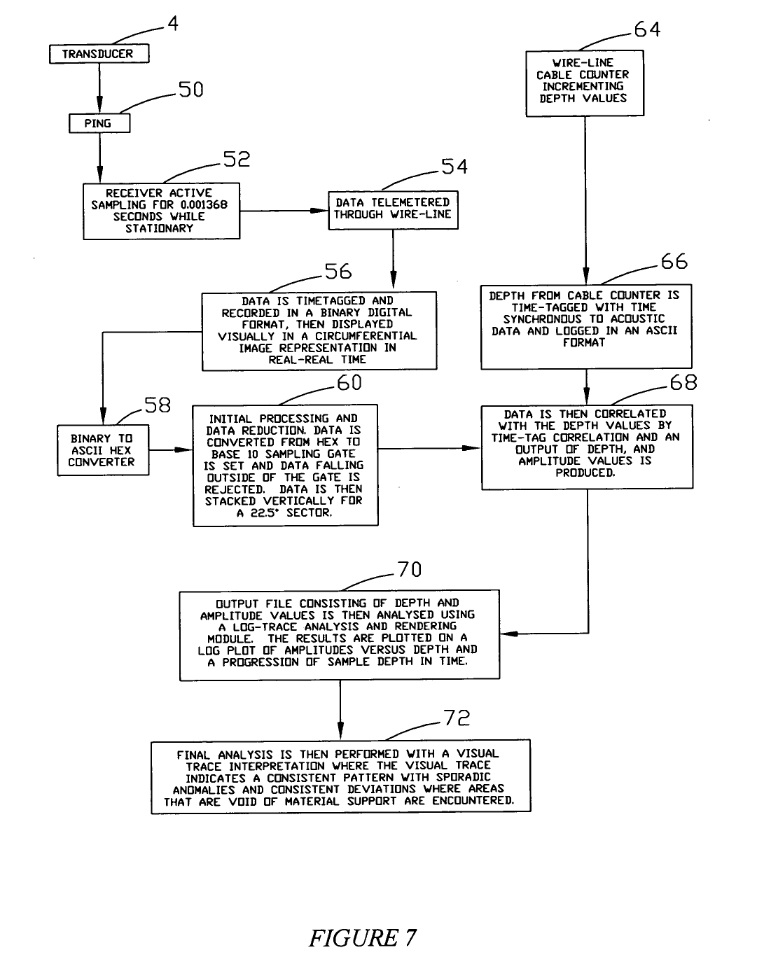

Referring now to FIGS. 6A through 6D, a sequential view of sonar ping initiation, reflection recordation, and rotation of the transducer 4 is illustrated. Please note that FIGS. 6A-6D are based on a preferred embodiment sampling rate of approximately 35 KHz and a scan step of 0.225 degrees. FIG. 6A is a plan view of the sensor/transducer 4 initiating an acoustic pulse in a tubular 14. In other words, the transducer 4 initiates an acoustic ping. Next, the transducer 4 remains stationary for 0.001368 seconds while receiving acoustic ping reflections, as seen in FIG. 6B. According to the teachings of the present invention, the transducer 4 will thereafter rotate an increment of 0.225 degrees and initiates another ping sequence, as seen in FIG. 6C. FIG. 6D illustrates where the transducer 4 is stationary for 0.001368 second while receiving acoustic ping reflections. This sequence continues for the entire 360-degree revolution. In fact, the device 2 is also being pulled through the tubular 14, and therefore, the sampling continues for the entire span of tubular being logged. The received acoustic data is transmitted via communication and control cabling in the wireline and recorded in a binary digital format in the surface computer. The data is also displayed in a visual representation of an acoustic image produced by mapping amplitude values to color and intensity.

Referring now to FIG. 7, a data flow diagram of the present invention will now be described. The acoustic signal 50, sometimes referred to as the ping, will be initiated by the transducer 4. The active sampling period for the receiver is for 0.001368 seconds while the receiver is stationary, as seen in step 52. The data is telemetered through the wireline, as shown in step 54. Next, the data is time tagged and recorded in a binary digital format, and then displayed visually in a circumferential image representation in real-time, which is denoted in step 56. The binary digital data is converted to ASCII via a “Simrad” binary converter to convert the data to ASCII hexadecimal format 58.

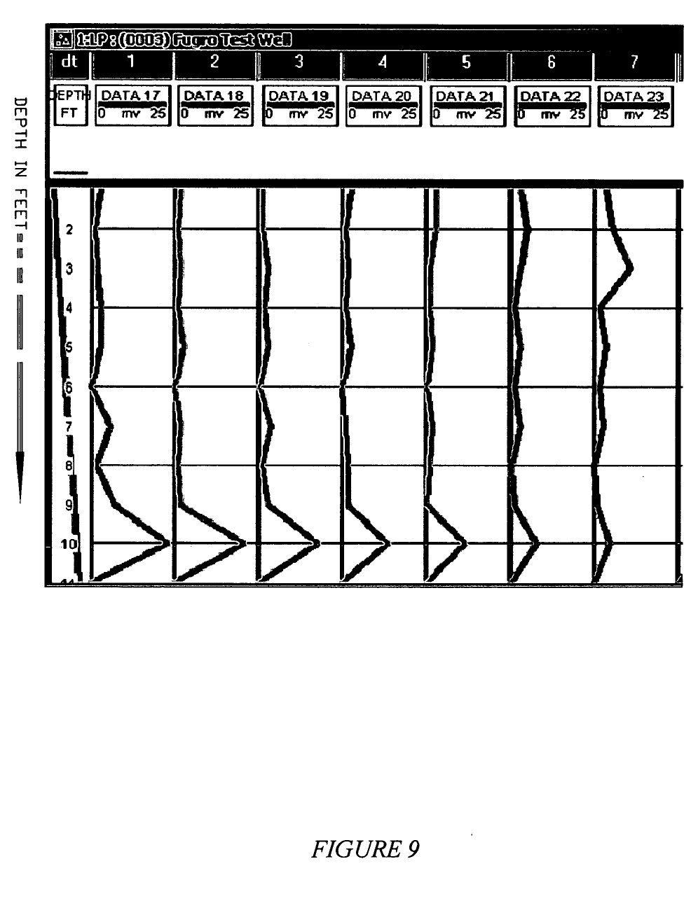

The initial processing and data reduction is performed next 60. Data is converted from Hex to base 10. The time gate is established defining a sample window of interest, and data falling outside of the gate is rejected. FIG. 8 depicts the time gate defined sample window with respect to the position of the tubular wall. More specifically, FIG. 8 is a time alignment diagram of the inner tubular wall position within the recorded samples at each ping/step of the transducer where time is represented in sample numbers. Forty-eight (48) samples are taken; the time gate then establishes a sample window such that conditions being ideal, the reflected acoustic pulse reflection from the perpendicular incident of the ping and the pipe wall occurs at the 16^{th} sample within the sample window thus putting the leading edge of the time gate at the 10^{th} sample. T₁ represents, in milliseconds, the leading edge of the sample gate, and T₂ represents the terminating edge of the sample gate. The data is then stacked vertically for a 22.5 degree sector.

Returning to FIG. 7, as the tool 2 is being pulled through the tubular, the depth count from the cable counter on the wireline unit is being utilized 64, and wherein the wireline cable counter is incrementing depth intervals. The depth from the cable counter is time tagged with time synchronous to acoustic data and logged in an ASCII format 66.

Next, the data from the stack and the cable counter is then correlated with the depth values by time-tag correlation and an output of depth, and amplitude values is produced 68. The output file consisting of depth and amplitude values is then analyzed using a log-trace analysis and rendering module. The results are plotted on a log plot of amplitudes versus depth and a progression of sample depth in time 70.

The final analysis is then performed with a visual trace interpretation where the visual trace indicates a consistent pattern with sporadic anomalies and consistent deviations of increasing amplitudes where areas that are void of material support are encountered, as noted in 72.

Due to sonar data being collected at every increment of 0.225 degree, a large data set is generated which due to storage and/or transmission issues may be undesirable in some instances. In an effort to reduce the data set, and according to the teachings of this invention, it is possible to designate a number of azimuthal sections to be mapped. For test case purposes, a selection of 16 azimuthal sections, which generates sixteen (16) 22.5 degree wide sections to encompass the entire 360 degree scan, displaying 16 sectors, with all of the data for each sector being essentially displayed in a vertical stack.

The time gate must then be established defining a sample window to qualify only those ping reflections samples that are of interest in determining the structural integrity of the bond. As mentioned earlier, offsetting the pipe wall approximately twenty-five percent (25%) from the leading edge of the sample gate generates the gate reference position (as seen in FIG. 8). In the preferred embodiment, the sample gate is to be 24 samples wide with the leading edge of the gate determined by the following:
T₀=d/s
T₁=(d/s)−(6(Sᵣ/Nₛ))
T₀=time of first expected ping reflection from the inner pipe wall 16;
d=distance from the transducer to the pipe wall times 2 (nominal pipe diameter);
s=speed of sound or propagation velocity in the fluid medium contained in the pipe.
T₁=leading edge of the sample gate in milliseconds from ping initiation.
Sᵣ=sample rate in Hz
Nₛ=number of samples per ping

The speed of sound is calculated for use as a reference by the following formula for the speed of sound in aqueous solutions:
C(m/s)=1449+4.6T=0 . . . 3T3+(1.39−o.012T)(S−35)+0.01D, Where:
C=speed of sound in meters per second;
S=density;
T=temperature;
D=depth.

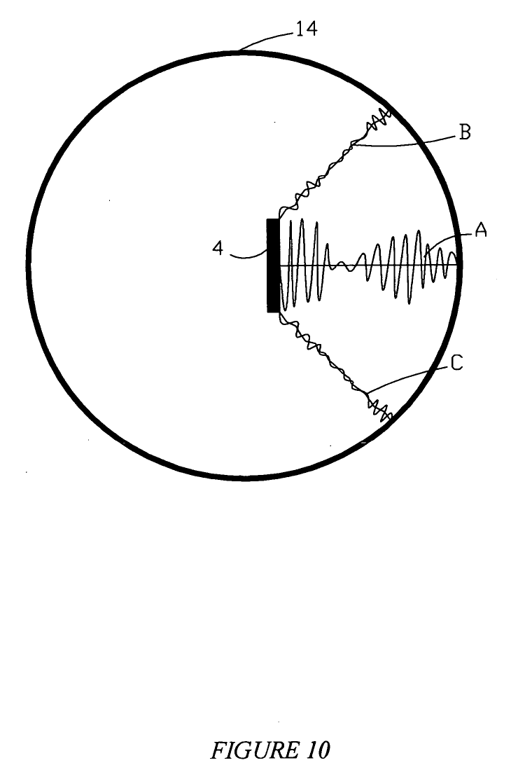

FIG. 9 is a representative log plot depicting a void surrounding the tubular in a test case. The example represents a 22.5 degree of arc sampling through a 26 inch cemented well casing with a known and mapped void. The graphed values are time samples from the pipe wall out, as previously described. The sample frequency is 35,105 Hz. As noted earlier, the total number of samples per ping is forty-eighth (48), data is clipped at the twenty-third (23) and the thirtieth (30) for the log plot of FIG. 9. The position of the pipe wall within the sample window is shifted in the test case due to a change in the sound propagation velocity. The velocity is slower in the lower density of fresh water. Also affecting the pipe wall position within the sample window is the lack of sensor centralization. The “dt” represents the trace which reflects a respective sample interval within a sample window. In other words, the seven traces dt represent successive samples at a 0.00002848 sec. time interval with the first trace being the first reflection of the perpendicular incidence of the ping and the inner tubular wall and successive traces being samples progressing in time that are produced by reverberation of the pipe wall producing compressional waves that attenuate over time. In FIG. 8 the 24 samples of the time gate defined sample window have been further reduced for the purposes of displaying only the pipe wall reflection and reverberation related samples. Thus, FIG. 9 depicts a void at approximately the ten (10) foot depth of the test tubular.

Nominal amplitudes along bonded section of the pipe wall are represented along with sporadic anomalous spikes, at the nine-foot to eleven-foot depth interval the void is detected, which matches the actual condition. The void is indicated by successive significantly higher amplitudes than the baseline established over the previous several feet. The amplitude spike is also sustained through several samples.

FIG. 10 is a plan view of the reflected acoustic compressional wave from the perpendicular incidence of the acoustic ping intersection with the inner tubular wall (I). Hence, the acoustic reflection “A,” produced by the transducer 4, is the wave form of interest on account of its perpendicular incidence. Due to the nature of the transducer 4 having the receiver only active for a time interval that is a function of the range desired and the ability of the sonar sensor to filter extraneous non-orthogonal reflections this allows the qualification of only those orthogonal acoustic reflections that are of interest to be qualified and displayed. Hence, acoustic reflections “B” and “C” would be rejected since they are obtuse, whereas “A” is accepted due to its perpendicular incidence.

The foregoing has been illustrative of the features and principles of the present invention. Changes and modifications may be made to the invention may be apparent to those skilled in the art without departing from the spirit and scope of the invention and any equivalents thereof.

1. A method for acoustically logging a tubular for an interface with a material, wherein the tubular is disposed within a bore hole so that an annulus is formed between the tubular and the borehole and the material is disposed within the annulus, the method comprising:
producing a first acoustic fan beam from an acoustic sensor located in said tubular;
recording a plurality of sample readings;
establishing a first time gate corresponding to a first set of sample readings, wherein said first set of sample readings are representative of the reflection of a perpendicular incidence of the acoustic fan beam and an inner tubular wall;
recording the first time gate;
rotating said acoustic sensor;
producing a second acoustic fan beam from the acoustic sensor.

2. The method of claim 1 further comprising:
establishing a second time gate corresponding to a second set of sample readings, wherein said second set of sample readings are representative of the reflection of the perpendicular incidence of the second acoustic fan beam and the inner tubular wall;
recording the second time gate.

3. The method of claim 2 further comprising:
positioning the acoustic sensor at a second depth;
establishing a third time gate corresponding to a third set of sample readings, wherein said third set of sample readings are representative of the reflection of the perpendicular incidence of the third acoustic fan beam and the inner tubular wall;
recording the third time gate;
recording a depth of acquisition corresponding to the depth of acquiring the plurality of sample readings;
time tagging the first, second and third time gate;
matching the first, second and third time gate to a depth of acquisition within said tubular.

4. The method of claim 3 wherein the step of establishing the time gates comprises:
determining the speed of sound in the fluid medium from known fluid characteristics of average density and average temperature;
calculating the position of the initial pipe wall reflection of the acoustic fan beam, in time from first acoustic fan beam initiation, wherein said sensor is centralized;
setting a window with the leading edge being six (6) samples before the calculated position of the initial pipe wall reflection of the acoustic pulse, through to seventeen (17) samples beyond the position of the initial pipe wall reflection of the acoustic pulse in time, so that a sample window of twenty-four (24) samples is provided.

5. The method of claim 4 wherein the step of establishing a first, second, and third time gate includes recording the first, second, and third set of sample readings in a recording means operatively associated with the acoustic sensor located within the tubular and directing the recorded samples to a surface processor, and the method further comprises processing the first, second, and third set of sample readings at the surface for bonding integrity with the material within the surface.

6. The method of claim 5 further comprising:
measuring an amplitude of the first, second, and third set of sample readings within the first, second and third time gate;
obtaining a first reflection set representing an interface with the material based on said amplitude;
obtaining a second reflection set having an amplitude approximately double said first reflection set amplitude, wherein said second reflection set represents a void.

7. The method of claim 1 wherein the first set of sample readings are obtained at a rate of approximately 35 KHz and wherein said first set of sample readings each comprises forty-eight (48) samples at each sensor step with said first time gate defined sample window defining a subset of samples containing twenty-four (24) contiguous samples.

8. The method of claim 7 wherein the step of rotating the acoustic sensor includes rotating the sonar in scan increments of 0.225 degrees.

9. A system for determining the integrity of an interface to a tubular comprising:
an acoustic fan beam generator for generating an acoustic beam, said beam generator located on a tool within the tubular, and wherein said beam generator generates a sonar data set, with said beam generator recording the sonar data set;
a surface processor receiving the sonar data set via a telemetry means for transmitting the sonar data set from within the tubular to a surface processor;
a time gate means, operatively associated with said surface processor, for establishing a time gate defining a sample window that is inclusive of samples representing compressional wave reflections from the perpendicular incidence of the acoustic beam and first contact with an inner wall of said tubular.

10. The system of claim 9 wherein said beam generator comprises a rotating transducer for rotating in a 360 degree phase within the tubular.

11. The system of claim 10 further comprising:
means, operatively associated with said beam generator, for recording the sonar data set.

12. The system of claim 11 wherein said telemetry means is an electric line connected at a first end to said acoustic fan beam generator and at a second end to the surface processor;
and wherein said surface processor contains means for converting the sonar data set to an amplitude file.

13. The system claim 12 wherein said surface processor includes an amplitude comparing means for comparing the amplitude file of the sonar data set.

14. The system of claim 13 wherein said beam generator time tags the data set and the surface processor synchronizes the time tagged data set with the amplitude file.

15. The system of claim 14 wherein said rotating transducer obtains samples at a rate of approximately 35 KHz.

16. A method for acoustically logging a tubular for an interface with a material, wherein the tubular is disposed within a bore hole so that an annulus is formed between the tubular and the borehole and the material is disposed within the annulus, the method comprising:
producing a first acoustic fan beam ping from an acoustic sensor located in said tubular;
establishing a first time gate, wherein the step of establishing the first time gate comprises:
determining the speed of sound in a fluid medium located within said tubular;
calculating the initial pipe wall reflection position of the ping, in time from ping initiation, wherein said sensor is centralized;
setting a first window with a leading edge of the window being six (6) samples before the calculated position of the initial pipe wall reflection of the acoustic pulse, through to seventeen (17) samples beyond the position of the initial pipe wall reflection of the acoustic pulse in time thereby obtaining a first sample window of twenty-four (24) samples.

17. The method of claim 16 further comprising:
rotating the acoustic sensor an incremental step;
producing a second acoustic fan beam ping from the acoustic sensor.

18. The method of claim 17 further comprising:
establishing a second time gate, wherein the step of establishing the second time gate comprises:
determining the speed of sound in the fluid medium from known fluid characteristics of average density and average temperature;
calculating the initial pipe wall reflection position of the ping, in time from ping initiation wherein said sensor is centralized;
setting a second window with the leading edge of the second window being six (6) samples before the calculated position of the initial pipe wall reflection of the acoustic pulse, through to seventeen (17) samples beyond the position of the initial pipe wall reflection of the acoustic pulse in time, thereby providing a second sample window of twenty-four (24) samples.

19. The method of claim 18 further comprising:
positioning the acoustic sensor at a second depth;
establishing a third time gate;
recording a third sample window defined by the third time gate;
time tagging the samples in the sample windows defined by the first, second and third time gate;
matching the sample windows defined by the time gate to a depth of acquisition.

20. The method of claim 19 further comprising:
measuring an amplitude of the readings within said first, second, and third sample windows defined by the first, second and third time gate;
obtaining a first reflection set representing an interface based on said amplitude;
obtaining a second reflection set having an amplitude double said amplitude, wherein said second reflection set represents a void.

21. The method of claim 20 wherein samples from said first, second, and third time gate are obtained at a rate of approximately 35 KHz and wherein said samples comprises forty-eight (48) samples at each incremental sensor step with a time gate defined sample window defining a subset of samples containing twenty-four (24) contiguous samples.

22. The method of claim 21 wherein the step of obtaining the samples includes recording the samples in a recording means operatively associated with the sensor within the tubular and directing the recorded samples to a surface processor, and the method further comprises processing the samples at the surface.

23. The method of claim 22 wherein the step of rotating the acoustic sonar includes rotating the acoustic sonar in step scan increments of 0.225 degrees.
